(19) United States
(12) Patent Application Publication
(10) Pub. No.: US 2008/0129200 A1
(43) Pub. Date: Jun. 5, 2008

(54) PLASMA DISPLAY PANEL AND METHOD OF MANUFACTURING THE SAME

(75) Inventors: Dong-Hyun Kang, Yongin-si (KR); Jong-Seo Choi, Suwon-si (KR); Yong-Seog Kim, Seoul (KR); Min-Su Co, Seoul (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/947,333

(22) Filed: Nov. 29, 2007

(30) Foreign Application Priority Data
Dec. 1, 2006 (KR) 2006120601

(51) Int. Cl. H01J 17/49; H01J 9/02

(52) U.S. Cl. 313/586; 445/24

(57) ABSTRACT

A plasma display panel and a method of making thereof such that the plasma display panel includes a first substrate and a second substrate arranged opposite to each other; a plurality of address electrodes disposed on the first substrate; a dielectric layer disposed to cover the address electrodes disposed on the first substrate; a plurality of display electrodes disposed to cross the address electrodes on a second substrate; an inorganic oxide layer disposed to cover the display electrodes; an MgO protective layer disposed to cover the inorganic oxide layer; barrier ribs disposed between the first substrate and the second substrate to define a plurality of discharge cells; and phosphor layers disposed in the discharge cells.

### CROSS-REFERENCE TO RELATED APPLICATION

This application claims the benefit of Korean Application No. 2006-120601, filed Dec. 1, 2006 in the Korean Intellectual Property Office on, the disclosure of which is incorporated herein by reference.

### BACKGROUND OF THE INVENTION

1. Field of the Invention

Aspects of the present invention relate to a plasma display panel and a method of manufacturing the same. More particularly, aspects of the present invention relate to a plasma display panel having excellent discharge characteristics and a low manufacturing cost, and a method of manufacturing the same.

2. Description of the Related Art

A plasma display panel is a display device that forms an image by exciting phosphor with vacuum ultraviolet (VUV) rays generated by gas discharge in discharge cells. Since a plasma display panel is capable of forming a large, high-resolution picture, it is drawing attention as a next-generation thin display device.

A three-electrode surface-discharge plasma display panel has been widely used. The three-electrode surface-discharge plasma display panel includes a front substrate and a rear substrate. Display electrodes, including a pair of electrodes, are disposed on the front substrate and covered by a dielectric layer, whereas address electrodes are disposed on the rear substrate. The space between the front substrate and the rear substrate is partitioned by barrier ribs into a plurality of discharge cells, which are filled with a discharge gas. A phosphor layer is disposed on the rear substrate and the barrier ribs.

Since an MgO protective layer causes emission of secondary electrons and exo-electrons in the discharge of a plasma display panel thereby decreasing are required a discharge voltage and decreasing discharge delay, MgO has been used as a protective layer to emit electrons from the initial development of the plasma display panel. The MgO protective layer for a plasma display panel has been formed in a vacuum deposition method, such as electron-beam evaporation, ion-plating, and sputtering by using a pure MgO deposition source.

There are increasing demands for reducing power consumption of the plasma display panel by improving the emission of secondary electrons from MgO and decreasing the initial discharge voltage, and for adding a doping element to the MgO protective layer to cut down on the costs for parts by a single scan operation. In short, the electron emission of MgO is actively controlled by adjusting the concentration and coupling energy level of MgO based on the doping element.

Methods of improving the electron emission of MgO by adding a doping element are disclosed in Japanese Patent Publication Nos. 2005-123172 and 2005-123173, Korean Patent Publication Nos. 2005-113685, 2006-69573, and 2005-75866, and U.S. Patent Publication No. 2006/0145614.

Japanese Patent Publication No. 2005-123173 suggests an MgO composition including at least one selected from the group consisting of Si, Ge, C, and Sn, and at least one selected from the group consisting of group 4 elements, group 5 elements, group 6 elements, and group 7 elements of the periodic table. The one selected from the group consisting of Si, Ge, C, and Sn is used in a doping concentration of 20 wt ppm to 8000 wt ppm, and the one selected from the group consisting of group 4 elements, group 5 elements, group 6 elements, and group 7 elements of the periodic table is used in a doping concentration of 10 wt ppm to 10,000 wt ppm.

Japanese Patent Publication No. 2005-123172 discloses the use of an MgO composition including a magnesium carbide such as MgC₂, Mg₂C₃, and Mg₃C₄. It suggests using the magnesium carbide in a concentration ranging from 50 wt ppm to 7000 wt ppm.

Korean Patent Publication No. 2005-75866 discloses a composition for a protective layer doped with Si. It describes that the discharge delay time is the shortest when the content of Si ranges from 20 ppm to 500 ppm. The contents of impurities are restricted. The content of Ca is restricted to be less than 50 ppm; Fe, less than 50 ppm; Al, less than 250 ppm; Ni, less than 5 ppm; Na, less than 5 ppm; and K, less than 5 ppm.

Korean Patent Publication No. 2005-113685 discloses an MgO protective layer using Ca, Al, Fe, and Si as dopants. The dopant elements interact and minimize the discharge delay time of a plasma display panel. The content of Ca ranges from 100 to 300 ppm, and the content of Al ranges from 60 to 90 ppm. The content of Fe ranges from 60 to 90 ppm, and the content of Si ranges from 40 to 100 ppm.

Korean Patent Publication No. 2006-69573 provides an MgO composition including at least one selected from the group consisting of rare earth elements and one selected from the group consisting of Al, Ca, and Si. It suggests a composition in which the content of Sc, which is a rare earth element, ranges from 50 to 600 ppm based on magnesium oxide and the contents of Ca, Al, and Si range from 50 to 400 ppm, individually. Also, the composition includes Mn, Na, K, Cr, Fe, Zn, Bi, Ni, and Zr as impurities. Herein, Mn is included in a content of less than 50 ppm based on magnesium oxide, and Na is included in a content of less than 30 ppm. K is included in a content of less than 30 ppm and Cr is included in a content of less than 10 ppm, while Fe is included in a content of less than 20 ppm.

U.S. Patent Publication No. 2006/0145614 discloses an MgO composition doped with Sc, Ca, and Si. According to the patent application, discharge delay time decreases remarkably when the content of Sc ranges from 50 ppm to 2000 ppm and the content of Ca ranges from 100 ppm to 1000 ppm while the content of Si ranges from 30 ppm to 500 ppm.

As described above, doping MgO with a doping element improves the characteristics of an MgO thin film to increase discharge efficiency and shorten discharge delay time. Ultimately, it improves the performance of a plasma display panel. However, when an MgO deposition composition includes Sc, costs for raw materials increase. When a doping element has a larger atomic weight than Mg, it has low mobility in a deposition atmosphere and the proportion that a thin film is doped with the doping element decreases, which is a problem. In short, the above methods dope a target source with the doping element in a vacuum deposition process. The methods have problems in that the doping element is not smoothly deposited onto a substrate in the vacuum deposition process.

Also, solubility of a doping element in MgO depends on the radius and valence of the ions. As the radius of a doping element ion becomes larger than that of an Mg ion and the difference between the valences becomes large, the solubility in MgO decreases. Therefore, doping elements with a large ion radius and valence are not used for doping due to their low solubility in the process of forming an MgO layer, and they are extracted as a second phase. The effect of improving discharge characteristics expected by the doping is not acquired.

The manufacturing costs associated with the thin film manufacturing process are high because the process is slow and manufacturing equipment is expensive. A thick film manufacturing process resolves the problem by stacking MgO powder to form a protective layer. The thick film manufacturing process is a method of forming a protective layer by preparing an MgO paste or a green sheet from MgO powder, forming a thick film in a printing or lamination method, and then performing drying and calcination. The thick film manufacturing process is disclosed in detail in Korean Patent Publication Nos. 2006-57920, 2005-20519, and 2005-81078, and 100186541 (published Dec. 29, 1998).

Korean Patent Publication No. 2006-57920 discloses a method of forming a protective layer by attaching a green sheet including MgO nano-powder onto the upper surface of a dielectric layer on a front panel by using a lamination method, and firing them. Herein, the thickness of the green sheet ranges from 20 μm to 100 μm. Korean Patent Publication No. 2005-20519 discloses a method of forming a protective layer by using MgO nano-powder having a particle diameter of less than 100 nm in a thick film manufacturing process, such as screen printing, dipping, dye coating, spin coating, green sheet coating, and inkjet, printing.

Korean Patent Publication No. 2005-81078 discloses a method of forming a protective layer by using a mixture of MgO powder having a particle diameter of less than 100 nm and a predetermined alkali metal powder or TiO2 powder. The thick film coating method has problems in that a lot of organic materials such as a solvent, a binder, and a dispersing agent are used to prepare a paste or a green sheet, and that a paste coating layer and a green sheet layer, which are not yet dried, become too thick to acquire an appropriate thickness.

Korean Patent Publication No. 100186541 (published Dec. 29, 1998) discloses a method of forming a dielectric layer and an MgO powder protective layer by performing electrophoresis. According to the method, a front substrate is coated by being immersed in an electrophoresis liquid where MgO powder is dispersed, connecting a negative electrode of a direct current (DC) power source to an electrode of the front substrate, and connecting a positive electrode of the power source to a metal electrode. The patent application provides a liquid composition prepared by using isopropyl alcohol as a solvent, and magnesium nitrate hydrate or yttrium nitrate hydrate as an additive.

The MgO thick film manufacturing method based on electrophoresis is widely known to those skilled in the art, and many researchers have studied to determine the effects of major process parameters on the characteristics of the MgO thick film. However, the thick film manufacturing method based on electrophoresis has a shortcoming in that the thick film is not uniformly formed on the surface of a dielectric layer because the MgO layer is formed primarily around the surface of electrodes where voltage is applied.

FIG. 1 is a schematic view showing a manufacturing process of an MgO protective layer using a conventional electrophoresis method. Referring to FIG. 1, a plurality of display electrodes 120 are disposed on one surface of a substrate 110, and a dielectric layer 130 is disposed on the entire substrate 110 covering the display electrodes 120. On top of the dielectric layer 130, an MgO protective layer 150 is disposed.

An electrophoresis liquid 160 is poured into a chamber 190, and a common electrode 180, which is connected to the positive (+) terminal of the DC power source 170, is placed in the electrophoresis liquid 160. Also, the negative (−) terminal of the DC power source 170 is connected to the display electrodes 120 of the second substrate 110, and the second substrate 110, connected to the negative terminal (−) of the DC power source 170, is immersed in the electrophoresis liquid 160. Subsequently, an MgO protective layer 150 is formed on the surface of the dielectric layer 130 covering the display electrodes 120 by performing electrophoresis.

When the MgO protective layer is formed by performing the conventional electrophoresis, the MgO protective layer is formed only in an area where the display electrodes 120 are formed. Also, there is a problem in that a high voltage of more than hundreds of volts should be applied to form the MgO thick film on the surface of the dielectric substance on the front substrate coated with the dielectric layer in a thickness of about 30 μm. This increases the manufacturing costs and endangers the safety of a device.

### SUMMARY OF THE INVENTION

According to aspects of the present invention, there is provided a plasma display panel having an excellent discharge characteristic.

According to aspects of the present invention, there is provided a method of manufacturing the plasma display panel where an MgO protective layer is formed using electrophoresis.

According to aspects of the present invention, provided is a plasma display panel that includes a first substrate and a second substrate arranged opposite to each other; a plurality of address electrodes disposed on the first substrate; a dielectric layer disposed to cover the plurality of address electrodes disposed on the first substrate; a plurality of display electrodes disposed on the second substrate to cross the plurality of address electrodes; an inorganic oxide layer disposed to cover the display electrodes; an MgO protective layer disposed to cover the inorganic oxide layer; barrier ribs disposed between the first substrate and the second substrate to define a plurality of discharge cells; and phosphor layers disposed in the discharge cells.

According to aspects of the present invention, the inorganic oxide layer may be disposed to correspond to the display electrodes of the second substrate while covering the display electrodes.

According to aspects of the present invention, the plasma display panel may further include a dielectric layer between the display electrodes and the inorganic oxide layer.

According to aspects of the present invention, the inorganic oxide layer may be patterned.

According to aspects of the present invention, the inorganic oxide layer has a thickness ranging from 10 to 1000 nm. According to another embodiment, the inorganic oxide layer has a thickness ranging from 100 to 300 nm.

According to aspects of the present invention, the inorganic oxide layer includes a non-noble metal oxide selected from the group consisting of aluminum oxide, magnesium oxide, chromium oxide, copper oxide, nickel oxide, and combinations thereof.

According to aspects of the present invention, the display electrode includes at least one metal selected from the group consisting of silver, aluminum, magnesium, copper, nickel, and combinations thereof.

According to aspects of the present invention, the MgO protective layer has a thickness ranging from 0.5 to 10 μm. According to one embodiment, the MgO protective layer has a thickness ranging from 1 to 5 μm.

According to aspects of the present invention, the MgO protective layer further includes a doping element selected from the group consisting of Sc, Al, Ca, Si, and combinations thereof.

According to aspects of the present invention, provided is a method of manufacturing a plasma display panel that includes forming a sacrificial electrode layer to cover a plurality of display electrodes disposed on a substrate; immersing the substrate in an electrophoresis liquid including MgO powder and a solvent; performing electrophoresis by applying a voltage to the sacrificial electrode layer to form an MgO protective layer on the sacrificial electrode layer; and oxidizing the sacrificial electrode layer into an optically transparent oxide.

According to aspects of the present invention, the manufacturing method further includes forming a dielectric layer between the display electrode and the inorganic oxide layer.

According to aspects of the present invention, the sacrificial electrode layer may be formed using a method selected from the group consisting of electroless plating, thermal deposition, sputtering, chemical deposition, and combinations thereof.

According to aspects of the present invention, the MgO powder further includes a doping element selected from the group consisting of Sc, Al, Ca, Si, and combinations thereof. The contents of the doping elements are as follows: the Sc content ranges from 50 to 600 ppm, the Al content ranges from 50 to 400 ppm, the Ca content 50 to 400 ppm, and the Si content ranges from 50 to 400 ppm, based on the total weight of the MgO powder, respectively.

According to aspects of the present invention, the MgO powder may include an impurity selected from the group consisting of Mn, Na, K, Cr, Fe, Zn, Bi, Ni, and combinations thereof. The Mn content is less than 50 ppm, the Na content is less than 30 ppm, the K content is less than 30 ppm, the Cr content is less than 10 ppm, and the Fe content is less than 20 ppm.

According to aspects of the present invention, the MgO powder has an average particle diameter ranging from 50 to 1000 nm. According to another embodiment, the MgO powder has an average particle diameter ranging from 100 to 500 nm.

According to aspects of the present invention, the solvent is selected from the group consisting of an alcohol-based solvent, a ketone-based solvent, and combinations thereof.

According to aspects of the present invention, the electrophoresis liquid may further include a dispersing agent.

According to aspects of the present invention, the dispersing agent is added in an amount of 0.5 to 2 wt % based on the total weight of the electrophoresis liquid.

According to aspects of the present invention, the oxidizing of the sacrificial electrode layer is performed at a temperature of 450 to 600° C. The oxidizing process of the sacrificial electrode layer may simultaneously be performed with a firing process of an MgO protective layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing a fabrication process of an MgO protective layer using a conventional electrophoresis method.

FIG. 2 is a partial exploded perspective view showing a plasma display panel according aspects of the present invention.

FIG. 3 is a schematic view showing a second substrate of a plasma display panel according to aspects of the present invention.

FIG. 4 is a schematic view showing a second substrate of a plasma display panel according to aspects of the present invention.

FIG. 5 is a schematic view showing a second substrate of a plasma display panel according to aspects of the present invention.

FIG. 6 is a schematic view showing a fabrication process of an MgO protective layer of a plasma display panel according to aspects of the present invention using an electrophoresis method.

FIG. 7 is a schematic view showing a fabrication process of an MgO protective layer of a plasma display panel according to aspects of the present invention using an electrophoresis method.

FIG. 8 is a schematic view showing a fabrication process of an MgO protective layer of a plasma display panel according to aspects of the present invention using an electrophoresis method.

FIG. 9 is a graph showing discharge efficiency of plasma display panels according to Examples 1 to 3 and Comparative Example 1.

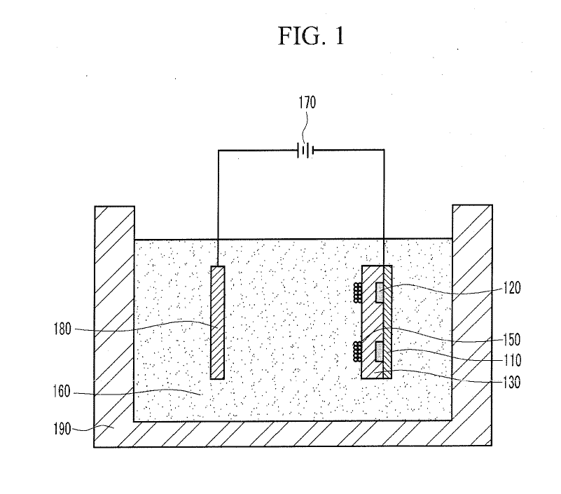

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. In addition, when a first component is said to be “disposed on” or “disposed to cover” a second component, the first element can directly contact the second element or directly cover while contacting the second element, or intervening elements can be therebetween. Further, if a first component is said to be “disposed to cover” a second component, the first component may completely or partially the second component, or be disposed to completely or partially cover an area corresponding to the second component if there is an intervening element.

According to aspects of the present invention, provided is a plasma display panel that includes a first substrate and a second substrate arranged opposite to each other; a plurality of address electrodes disposed on the first substrate; a dielectric layer covering the address electrodes disposed on the first substrate; a plurality of display electrodes disposed in a crossing direction to that of the address electrodes on a second substrate; an inorganic oxide layer disposed on the display electrodes; an MgO protective layer disposed covering the inorganic oxide layer; barrier ribs disposed in a space between the first substrate and the second substrate to partition a plurality of discharge cells; and phosphor layers disposed in the discharge cells.

The inorganic oxide layer may have a thickness ranging from 10 to 1000 nm. According to aspects, the inorganic oxide layer has a thickness ranging from 100 to 300 nm.

When the inorganic oxide layer is thinner than 10 nm, the electrical resistance increases to thereby decrease electrical conductivity. When the inorganic oxide layer is thicker than 1000 nm, the dielectric constant of the dielectric substance may be changed and the discharge characteristics may be deteriorated to thereby reduce brightness.

The inorganic oxide layer includes non-noble metal oxide selected from the group consisting of aluminum oxide, magnesium oxide, chromium oxide, copper oxide, nickel oxide, and combinations thereof.

The display electrode includes at least one metal selected from the group consisting of silver, aluminum, magnesium, copper, nickel, and combinations thereof.

The MgO protective layer has a thickness ranging from 0.5 to 10 μm. According to aspects, the MgO protective layer has a thickness ranging from 1 to 5 μm. Generally, as the MgO protective layer becomes thicker, discharge efficiency increases but visible light transmittance decreases and discharge voltage increases. When the thickness of the MgO protective layer is within the range, it is desirable because it is possible to increase discharge efficiency while maintaining the discharge voltage in a predetermined range.

The MgO protective layer further includes a doping element selected from the group consisting of Sc, Al, Ca, Si, and combinations thereof. When the MgO protective layer further includes the doping element, it is possible to improve discharge efficiency and shorten discharge delay time to thereby improve the performance of a plasma display panel.

In the following detailed description, only certain aspects of the present invention have been shown and described, simply by way of illustration. As those skilled in the art would realize, the described aspects may be modified in various different ways, all without departing from the spirit or scope of the present invention.

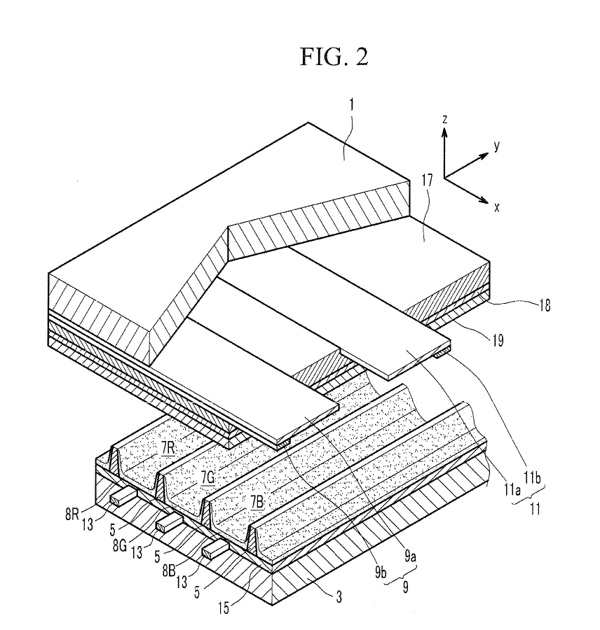

FIG. 2 is a partial exploded perspective view showing a structure of a plasma display panel according to aspects of the present invention. Referring to FIG. 2, the plasma display panel includes a first substrate 3, a plurality of address electrodes 13 disposed in one direction (a Y direction in the drawing) on the first substrate 3, and a first dielectric layer 15 disposed on the surface of the first substrate 3 covering the address electrodes 13. Barrier ribs 5 are formed on the first dielectric layer 15, and red (R), green (G), and blue (B) phosphor layers 8R, 8G, and 8B are disposed in discharge cells 7R, 7G, and 7B formed between the barrier ribs 5.

The barrier ribs 5 may be formed in any shape as long as their shape can partition the discharge space, and the barrier ribs 5 have diverse patterns. For example, the barrier ribs 5 may be formed as an open type, such as stripes, or as a closed type, such as a waffle, matrix, or delta shape. Also, the closed-type barrier ribs may be formed such that a horizontal cross-section of the discharge space is a polygon such as quadrangle, triangle, pentagon, or a circle or an oval.

Display electrodes 9 (11) include a transparent electrode 9a (11a) and a bus electrode 9b (11b). The display electrodes 9 and 11 are disposed in a direction crossing the address electrodes 13 (an X direction in the drawing) on one surface of a second substrate 1 disposed to face the first substrate 3. Also, a second dielectric layer 17 is disposed on the surface of the second substrate 1 while covering the display electrodes 9 and 11. Although FIG. 2 shows the display electrodes 9 and 11 disposed to perpendicularly cross the address electrodes 13, it is understood that the display electrodes 9 and 11 and the address electrodes 13 need not cross at a right angle and that they may cross at different and differing angles.

An inorganic oxide layer 18 and an MgO protective layer 19 are disposed on the surface of the second dielectric layer 17 of the second substrate 1.

Discharge cells are formed at positions where the address electrodes 13 of the first substrate 3 are crossed by the display electrodes 9 and 11 of the second substrate 1.

In the plasma display panel, address discharge is performed by applying an address voltage (Va) to a space between the address electrodes 13 and the display electrodes 9 and 11. When a sustain voltage (Vs) is applied to a space between a pair of display electrodes 9 and 11, an excitation source generated from the sustain discharge excites a corresponding phosphor layer to thereby emit visible light through the second substrate 1 and display an image. The phosphors are generally excited by vacuum ultraviolet (VUV) rays.

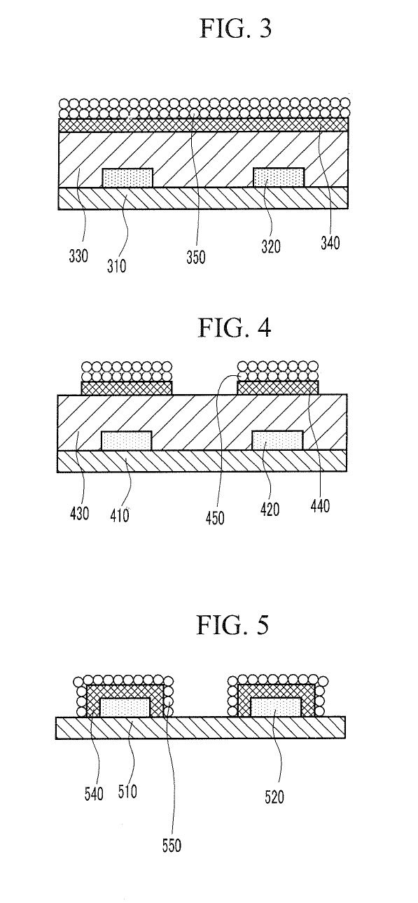

FIG. 3 is a schematic view showing a second substrate of a plasma display panel according to aspects of the present invention. Referring to FIG. 3, a plurality of display electrodes 320 is formed in one surface of the second substrate 310, and a dielectric layer 330 is formed on the entire surface of the second substrate 310 while covering the display electrodes 320. On top of the dielectric layer 330, an inorganic oxide layer 340 and an MgO protective layer 350 are disposed.

The inorganic oxide layer may have a thickness ranging from 10 to 1000 nm. According to aspects, the inorganic oxide layer may have a thickness ranging from 100 to 300 nm. The inorganic oxide layer includes oxides selected from the group consisting of aluminum oxide, magnesium oxide, chromium oxide, copper oxide, nickel oxide, and combinations thereof.

The display electrodes 9 and 11 include at least one metal selected from the group consisting of silver, aluminum, magnesium, copper, nickel, and combinations thereof.

The MgO protective layer has a thickness ranging from 0.5 to 10 μm. According to aspects, the MgO protective layer may have a thickness ranging from 1 to 5 μm. The MgO protective layer further includes a doping element selected from the group consisting of Sc, Al, Ca, Si, and combinations thereof.

FIG. 4 is a schematic view showing a second substrate of a plasma display panel according to aspects of the present invention. Referring to FIG. 4, a plurality of display electrodes 420 are disposed on one surface of the second substrate 410, and a dielectric layer 430 is disposed on the entire surface of the second substrate 410 while covering the display electrodes 420. On top of the dielectric layer 430, an inorganic oxide layer 440 and an MgO protective layer 450 are disposed.

Herein, the inorganic oxide layer 440 is patterned according to a pattern of the display electrodes 420 and disposed on the dielectric layer 430. The inorganic oxide layer 440 may be patterned in diverse forms such as a quadrangle and a T-shape as the display electrodes 420 are patterned in diverse forms such as a quadrangle and a T-shape. Also, the inorganic oxide layer 440 may be patterned according to the pattern of the display electrodes 420, when there is no dielectric layer 430. Further, the MgO protective layer 450 may be formed on inorganic oxide layer 440 having the same shape thereof.

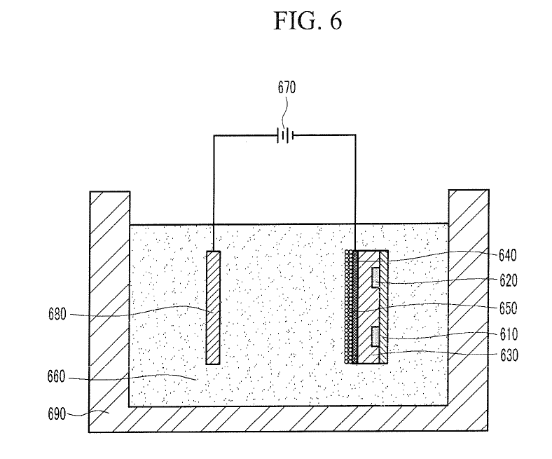

FIG. 5 is a schematic view showing a second substrate of a plasma display panel according to aspects of the present invention. Referring to FIG. 5, a plurality of display electrodes 520 are disposed on one surface of the second substrate 510, and an inorganic oxide layer 540 is disposed on the display electrodes 520. Also, an MgO protective layer 550 is disposed on the second substrate 510 while covering the inorganic oxide layer 540.

The inorganic oxide layer 540 is formed only in an area where the display electrodes 520 are formed on the second substrate 510, while covering the display electrodes 520. The inorganic oxide layer 540 replaces the dielectric layer. Since it can be formed thin, the voltage used for manufacturing the MgO protective layer 550 through electrophoresis can be reduced, which is desirable.

The plasma display panel according to aspects of the present invention is manufactured through forming a sacrificial electrode layer on display electrodes disposed on a substrate; immersing the substrate in an electrophoresis liquid including MgO powder and a solvent; performing electrophoresis by applying a voltage to the sacrificial electrode layer to form an MgO protective layer; and oxidizing the sacrificial electrode layer.

First, display electrodes are formed on a substrate, and then a sacrificial electrode layer is formed on the display electrodes. When the plasma display panel is manufactured according to aspects of the present invention, a dielectric layer is further formed between the display electrodes and the sacrificial electrode layer. The sacrificial electrode layer may be patterned. The sacrificial electrode layer may be formed at a thickness ranging from 10 to 1000 nm. According to aspects, the sacrificial electrode layer may be formed at a thickness ranging from 100 to 300 nm.

When the thickness of the sacrificial electrode layer is within the range, the sacrificial electrode layer has an electrical conductivity that can induce electrophoresis. The sacrificial electrode layer is easily oxidized at the firing temperature of the MgO protective layer ranging from 450 to 600° C. so as to convert the sacrificial electrode into an optically transparent oxide.

The sacrificial electrode layer may be formed using a method selected from the group consisting of electroless plating, thermal deposition, sputtering, chemical deposition, and combinations thereof. The sacrificial electrode layer includes a non-noble metal selected from the group consisting of aluminum, magnesium, chromium, copper, nickel, and combinations thereof. For the non-noble metal, a metal having a lower redox potential than silver may be used. Further, a non-noble metal that is easily oxidized and oxides thereof that are transparent may be appropriate.

The electrophoresis liquid is prepared by mixing an MgO powder with a solvent. The MgO powder further includes a doping element selected from the group consisting of Sc, Al, Ca, Si, and combinations thereof. The contents of the doping elements may be as follows: the Sc content ranges from 50 to 600 ppm and the contents of Al, Ca and Si respectively range from 50 to 400 ppm based on the total weight of the MgO powder.

When the doping element selected from the group consisting of Sc, Al, Ca, Si, and combinations thereof is included in a content less than the minimum amount of the range, the doping element exists in the MgO protective layer in an insignificant amount so that it cannot be expected that the discharge efficiency is improved and the discharge delay time is shortened. When the selected doping element is included in an amount exceeding the maximum amount of the range, not MgO but a second phase, i.e., SiO₂ and Al₂O₃, may be extracted, which is undesirable.

Additionally, the MgO powder may include an impurity selected from the group consisting of Mn, Na, K, Cr, Fe, Zn, Bi, Ni, and combinations thereof. The Mn content is less than 50 ppm, and the contents of Na and K are less than 30 ppm. The Cr content is less than 10 ppm, and the Fe content is less than 20 ppm. When the impurity contents are out of the range, it is not easy to control the amount of the doping element in the MgO powder, and the efficiency of including the doping element in the MgO protective layer is reduced, which is not desirable.

The MgO powder has an average particle diameter ranging from 50 to 1000 nm. According to another embodiment, the MgO powder has an average particle diameter ranging from 100 to 500 nm. When the average particle diameter of the MgO powder is within the range, a precipitation reaction does not occur during the electrophoresis, and the MgO powder can be uniformly packed onto the surface of the dielectric substance.

The solvent may be a polar solvent that can easily form a charged layer on the surface of the MgO powder. The solvent may be one selected from the group consisting of alcohol-based solvents, ketone-based solvents, and combinations thereof. Particularly, the drying speed and surface tension of the solvent affect the generation of a defect on the MgO protective layer formed through the electrophoresis, and its viscosity affects the speed at which the protective layer is formed. Thus, it is important to select a solvent of an appropriate combination of characteristics.

Examples of the alcohol-based solvent include at least one selected from the group consisting of methanol, ethanol, N-propyl alcohol, isopropyl alcohol, N-butanol, sec-butanol, iso-butanol, tert-butanol, N-amyl alcohol, isoamyl alcohol, sec-amyl alcohol, tert-amyl alcohol, N-hexyl alcohol, cyclohexanol, 2-ethyl-1-butanol, methyl isobutyl carbinol, 2-ethyl-1-hexanol, N-octyl-alcohol, sec-octyl alcohol), nonyl alcohol, decyl alcohol, benzyl alcohol, allyl alcohol, diacetone alcohol, furfuryl alcohol, tetrahydrofurfuryl alcohol, texanol ester-alcohol, and combinations thereof.

Examples of the ketone-based solvent includes at least one selected from the group consisting of acetone, methylethylketone, methyl N-propyl ketone, methyl isopropyl ketone, diethyl ketone, cyclo-hexanone, mesityl oxide ketone, methyl isobutyl ketone, methyl N-butyl ketone, ethyl N-butyl ketone, methyl N-amyl ketone, methyl isoamyl ketone, dipropyl ketone, diacetone alcohol, aceto-phenone, methyl N-hexyl ketone, ethyl N-amyl ketone, iso-phorone, diiso-butyl ketone, isobutyl heptyl ketone, EASTMAN C-11 (manufactured by Eastman Chemical Company), acetonyl-acetone, and combinations thereof.

The MgO powder may be included in an amount ranging from 0.1 to 10 wt % based on the entire amount of the electrophoresis liquid, and more specifically from 0.5 to 3 wt %. When the amount of the MgO powder is less than 0.1 wt %, the MgO protective layer cannot be formed to a sufficient thickness. When the amount exceeds 10 wt %, the concentration of the MgO powder is so thick that MgO is applied to areas other than the area where the MgO protective layer is to be formed, which is not desirable.

A dispersing agent may be added to the electrophoresis liquid to make the MgO powder exist in the state of suspension in which the MgO powder is dispersed in the electrophoresis liquid. The dispersing agent may be added to the solvent first to make the dispersing agent adsorbed onto the surface of the MgO powder so that the MgO powder is dispersed easily. To make the dispersion easier, the electrophoresis liquid may be treated with a flattening mill, a ball mill, an attrition mill, or a basket mill.

The dispersing agent may be added in an amount of 0.5 to 2 wt % based on the entire amount of the electrophoresis liquid. When the content of the dispersing agent is within such range, the dispersion of the MgO powder is improved and deposition can be performed uniformly. Also, it is possible to control the speed and direction of electrophoresis by changing the surface potential of the MgO powder. The content of the dispersing agent is determined according to the surface area of the MgO powder. When the MgO powder has a large surface area, i.e., a large number of small particles, it is desirable to increase the content of the dispersing agent. When the particles of the MgO powder are big and the surface area of the MgO powder is small, it is desirable to reduce the content of the dispersing agent.

Examples of the dispersing agent include at least one selected from the group consisting of DARVAN 821A (RT Vanderbilt Company Inc.), polyacrylic acid, hydroxypropyl cellulose, ammonium polymethacrylate, polymethacrylic acid, ethylenediaminetetraacetic acid, sodium hexametaphosphate, AEROSOL 22 (Cytec Industries), palmitic acid, BYK-180 (BYK Chemical Company), BYK-181 (BYK Chemical Company), BYK-111 (BYK Chemical Company), BYK-116 (BYK Chemical Company), and combinations thereof.

A common electrode connected to the positive (+) terminal of the DC power source is placed in the electrophoresis liquid. The negative (−) terminal of the DC power source is connected to the sacrificial electrode layer of the substrate, and the substrate connected to the negative terminal is immersed in the electrophoresis liquid. Subsequently, an MgO protective layer is formed on the surface of the sacrificial electrode layer surface by performing electrophoresis.

The MgO protective layer may be formed in a thickness ranging from 0.5 to 10 μm, and more specifically from 1 to 5 μm. Generally, the thicker the MgO protective layer is, the higher the discharge efficiency becomes. However, the visible light transmittance decreases and the discharge voltage increases. When the thickness of the MgO protective layer is within the range, discharge efficiency can be increased while the discharge voltage is maintained within a predetermined range.

FIG. 6 is a schematic view showing a fabrication process of an MgO protective layer of a plasma display panel according to aspects of the present invention using an electrophoresis method. Referring to FIG. 6, a plurality of display electrodes 620 are disposed on one surface of a substrate 610, and a dielectric layer 630 is disposed on the entire substrate 610 while covering the display electrodes 620. On top of the dielectric layer 630, a sacrificial electrode layer 640 and an MgO protective layer 650 are disposed.

An electrophoresis liquid 660 is poured in a chamber 690, and a common electrode 680 connected to the positive (+) terminal of a DC power source 670 is placed in the electrophoresis liquid 660. The above-prepared sacrificial electrode layer 640 of the substrate 610 is connected to the negative (−) terminal of the DC power source 670, and the substrate 610 connected to the negative (−) terminal is dipped into the electrophoresis liquid 660. Subsequently, electrophoresis is performed to thereby form an MgO protective layer 650 on the surface of the sacrificial electrode layer 640.

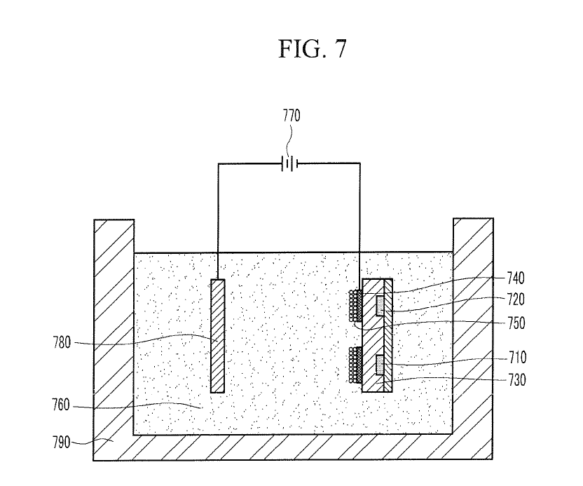

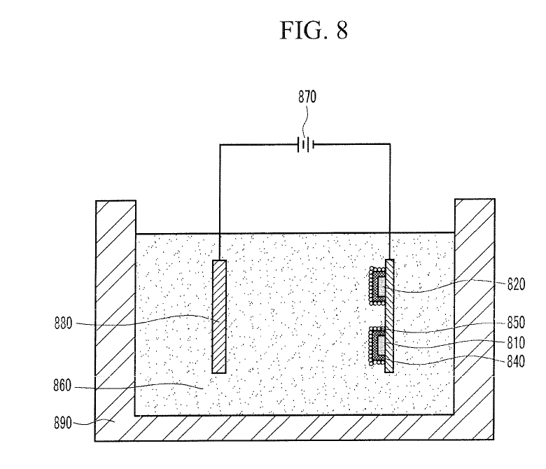

FIG. 7 is a schematic view showing a fabrication process of an MgO protective layer of a plasma display panel according to aspects of the present invention using an electrophoresis method. Referring to FIG. 7, a plurality of display electrodes 720 are disposed on one surface of a substrate 710, and a dielectric layer 730 is disposed on the entire substrate 710 while covering the display electrodes 720. On top of the dielectric layer 730, a sacrificial electrode layer 740 and an MgO protective layer 750 are disposed. Herein, the sacrificial electrode layer 740 is patterned and disposed on the dielectric layer 730. The sacrificial electrode layer 740 may be patterned in any shape, such as a quadrangle and a T-shape. A thin film having excellent anti-sputtering characteristics, such as Al₂O₃, MgO, and ZrO₂, may be disposed to prevent the dielectric layer 730 exposed to the discharge space from being etched out by the sputtering.

An electrophoresis liquid 760 is poured into a chamber 790, and a common electrode 780 connected to the positive (+) terminal of a DC power source 770 is placed in the electrophoresis liquid 760. The sacrificial electrode layer 740 of the substrate 710 is connected to the negative (−) terminal of the DC power source 770, and the substrate 710 connected to the negative (−) terminal is immersed in the electrophoresis liquid 760. Subsequently, electrophoresis is carried out to thereby form an MgO protective layer 750 on the surface of the sacrificial electrode layer 740.

FIG. 8 is a schematic view showing a fabrication process of an MgO protective layer of a plasma display panel according to aspects of the present invention using an electrophoresis method. Referring to FIG. 8, a plurality of display electrodes 820 are disposed on one surface of a substrate 810, and a sacrificial electrode layer 840 is disposed on the display electrodes 820. An MgO protective layer 850 is disposed on the substrate 810 while covering the sacrificial electrode layer 840.

The sacrificial electrode layer 840 is formed only in a region where the display electrodes 820 are formed on the substrate 810, while covering the display electrodes 820. Since the sacrificial electrode layer 840 may be thinly formed, it is possible to form an MgO protective layer 850 at a low voltage.

Meanwhile, it is possible to simultaneously form the display electrodes 820 and the sacrificial electrode layer 840 by forming the display electrodes 820 of a metal that can be oxidized. In short, it is possible to form the display electrodes 820 and the sacrificial electrode layer 840 of a metal that can be oxidized in an integrated form, to form the MgO protective layer 850 through electrophoresis, and to form an inorganic oxide layer by oxidizing the display electrodes 820 to a predetermined depth.

An electrophoresis liquid 860 is poured in a chamber 890, and a common electrode 880 connected to the positive (+) terminal of the DC power source 870 is placed in the electrophoresis liquid 860. Also, the negative (−) terminal of the DC power source 870 is connected to the sacrificial electrode layer 840 of the substrate 810, and the substrate connected to the negative (−) terminal is immersed in the electrophoresis liquid 860. Subsequently, the MgO protective layer 850 is disposed on the surface of the sacrificial electrode layer 840 by performing electrophoresis.

After the MgO protective layer 650, 750, or 850 is formed, the solvent is dried and the sacrificial electrode layer 640, 740, or 840 is oxidized, and then the MgO protective layer 650, 750, or 850 is fired. The oxidation of the sacrificial electrode layer 640, 740, or 840 may be carried out simultaneously with the firing of the MgO protective layer 650, 750, or 850. When the sacrificial electrode layer 640, 740, or 840 is oxidized, the sacrificial electrode layer 640, 740, or 840 is turned into an oxide, which is an insulator.

The oxidation of the sacrificial electrode layer may be carried out at a temperature ranging from 450 to 600° C. When the sacrificial electrode layer is oxidized at a temperature within such range, it is possible to perform both firing of the MgO protective layer and oxidation of the sacrificial electrode layer simultaneously.

The following examples illustrate aspects of the present invention in more detail. However, it is understood that the aspects of the present invention are not listed by these examples.

Manufacturing of a Plasma Display Panel

### Example 1

1 g of MgO powder, 60 ml of isopropylalcohol and 40 ml of 2-butanol were mixed to thereby prepare an electrophoresis liquid. Display electrodes were disposed on a substrate, and a dielectric layer was disposed on the display electrodes. Then, a sacrificial electrode layer was formed in a thickness of 20 nm on the dielectric layer with a thermal deposition/sputtering method.

The electrophoresis liquid was poured into a chamber, and a common electrode connected to the positive (+) terminal of a DC power source was placed in the electrophoresis liquid. The negative (−) terminal of the DC power source was connected to the sacrificial electrode layer of the substrate, and the substrate connected to the negative (−) terminal was immersed in the electrophoresis liquid. Subsequently, electrophoresis was performed to thereby form an MgO protective layer on the surface of the sacrificial electrode layer in a thickness of 1 μm. A plasma display panel was manufactured by using the substrate.

### Example 2

A plasma display panel was manufactured by performing the same procedure as in Example 1, except that the thickness of the MgO protective layer was 2 μm.

### Example 3

A plasma display panel was manufactured by performing the same procedure as in Example 1, except that the thickness of the MgO protective layer was 3 μm.

### Example 4

A plasma display panel was manufactured by performing the same procedure as in Example 1, except that the thickness of the MgO protective layer was 4 μm.

### Example 5

A plasma display panel was manufactured by performing the same procedure as in Example 1, except that the thickness of the MgO protective layer was 5 μm.

### Comparative Example 1

A second substrate was fabricated by forming an MgO protective layer in a thickness of 0.7 μm by using an ion plating method, and a plasma display panel was manufactured by using the second substrate.

### Comparative Example 2

A plasma display panel was manufactured by performing the same procedure as Example 1, except that the sacrificial electrode layer was not formed and the display electrodes were connected to the negative (−) electrode of the DC power source.

### Example 6

A plasma display panel was manufactured by performing the same procedure as in Example 1, except that the sacrificial electrode layer was patterned in the shape of a quadrangle.

### Example 7

A plasma display panel was manufactured by performing the same procedure as in Example 1, except that the dielectric layer was not formed on the display electrodes and the sacrificial electrode layer was formed only in an area where the display electrodes were formed to thereby cover the display electrodes.

### Example 8

A plasma display panel was manufactured by performing the same procedure as in Example 1, except that MgO powder including 1000 ppm of Sc, 1000 ppm of Al, 1000 ppm of Ca, and 1000 ppm of Si based on MgO were used.

### Example 9

A plasma display panel was manufactured by performing the same procedure as in Example 1, except that the dispersing agent BYK-180 (produced by the BYK Chemical Company) was added to the electrophoresis liquid in an amount of 0.6 wt % based on the entire amount of the electrophoresis liquid.

Measurement of Discharge Efficiency of the Manufactured Plasma Display Panel and Results Thereof

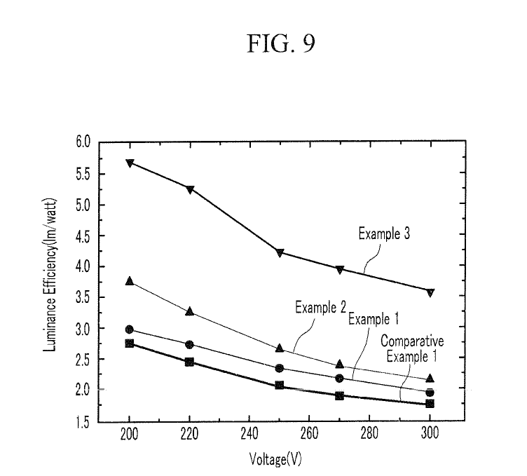

Discharge efficiencies of the plasma display panels manufactured according to Examples 1 to 9 and Comparative Example 1 were measured, and the measurement results of Examples 1, 2, and 3 and Comparative Example 1 are presented in FIG. 9.

It can be seen from FIG. 9 that the plasma display panels manufactured according to Examples 1, 2, and 3 had excellent discharge efficiency, compared to the plasma display panel manufactured according to Comparative Example 1. Also, when the MgO protective layer was formed through electrophoresis, the discharge efficiency increased as the MgO protective layer became thicker. The discharge efficiencies of the plasma display panels manufactured according to Examples 4 to 9 were similar to that of Example 1.

The plasma display panel manufactured according to Example 1 had an MgO protective layer disposed in a uniform thickness on the entire dielectric layer. However, in the plasma display panel manufactured according to Comparative Example 2, the MgO protective layer was not formed in a uniform thickness on the entire dielectric layer, but it was formed only on the display electrodes.

Since the MgO protective layer is formed by performing electrophoresis with the MgO powder doped with a predetermined amount of an element, the plasma display panel including the MgO protective layer has excellent discharge characteristics, such as improved discharge efficiency and reduced discharge time.

In addition, since the fabrication process of an MgO protective layer is simple and the quality is controlled uniformly and stably to thereby increase throughput, the method of manufacturing a plasma display panel according to aspects of the present invention can reduce the production cost of the plasma display panel remarkably.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel, comprising:
a first substrate and a second substrate arranged opposite to each other;
a plurality of address electrodes disposed on the first substrate;
a dielectric layer disposed to cover the plurality of address electrodes disposed on the first substrate;
a plurality of display electrodes disposed on the second substrate to cross the plurality of address electrodes;
an inorganic oxide layer disposed to cover the display electrodes;
an MgO protective layer disposed to cover the inorganic oxide layer;
a barrier rib disposed between the first substrate and the second substrate to define a plurality of discharge cells; and
a phosphor layer disposed in each discharge cell of the plurality of discharge cells.

2. The plasma display panel of claim 1, which further comprises a dielectric layer between each display electrode and the inorganic oxide layer.

3. The plasma display panel of claim 1, wherein the inorganic oxide layer is patterned.

4. The plasma display panel of claim 1, wherein the inorganic oxide layer is disposed to cover to each display electrode of the second substrate while not covering portions of the second substrate.

5. The plasma display panel of claim 1, wherein the inorganic oxide layer has a thickness ranging from 10 to 1000 nm.

6. The plasma display panel of claim 5, wherein the inorganic oxide layer has a thickness ranging from 100 to 300 nm.

7. The plasma display panel of claim 1, wherein the inorganic oxide layer comprises a non-noble metal oxide.

8. The plasma display panel of claim 7, wherein the inorganic oxide layer comprises an oxide selected from the group consisting of aluminum oxide, magnesium oxide, chromium oxide, copper oxide, nickel oxide, and combinations thereof.

9. The plasma display panel of claim 1, wherein each display electrode comprises at least one metal selected from the group consisting of silver, aluminum, magnesium, copper, nickel, and combinations thereof.

10. The plasma display panel of claim 1, wherein the MgO protective layer has a thickness ranging from 0.5 to 10 μm.

11. The plasma display panel of claim 10, wherein the MgO protective layer has a thickness ranging from 1 to 5 μm.

12. The plasma display panel of claim 1, wherein the MgO protective layer further comprises a doping element selected from the group consisting of Sc, Al, Ca, Si, and combinations thereof.

13. The plasma display panel of claim 1, wherein each display electrode is oxidized to a predetermined depth to form sacrificial electrodes, and the sacrificial electrodes are further oxidized to form the inorganic oxide layer.

14. The plasma display panel of claim 2, wherein the dielectric layer completely covers each display electrode and the second substrate.

15. The plasma display panel of claim 14, wherein the inorganic oxide layer is disposed to cover only portions of the dielectric layer corresponding to each display electrode.

16. The plasma display panel of claim 14, wherein the inorganic oxide layer is disposed to entirely cover the dielectric layer in areas corresponding to each display electrode.

17. The plasma display panel of claim 1, wherein the MgO protective layer is formed by performing electrophoresis using the inorganic oxide layer as a sacrificial electrode to deposit MgO powder on the inorganic oxide layer from an electrophoresis solution.

18. The plasma display panel of claim 17, wherein the MgO powder is doped with a predetermined amount of an element selected from the group consisting of Sc, Al, Ca, Si, and combinations thereof.

19. A method of manufacturing a plasma display panel, the method comprising:
forming a sacrificial electrode layer to cover a plurality of display electrodes disposed on a substrate;
immersing the substrate in an electrophoresis liquid including MgO powder and a solvent;
performing electrophoresis by applying a voltage to the sacrificial electrode layer to form an MgO protective layer on the sacrificial electrode layer; and
oxidizing the sacrificial electrode layer into an optically transparent oxide.

20. The method of claim 19, further comprising forming a dielectric layer between each display electrode and the inorganic oxide layer.

21. The method of claim 19, wherein the sacrificial electrode layer is patterned.

22. The method of claim 19, wherein the sacrificial electrode layer has a thickness ranging from 10 to 1000 nm.

23. The method of claim 22, wherein the sacrificial electrode layer has a thickness ranging from 100 to 300 nm.

24. The method of claim 19, wherein the sacrificial electrode layer comprises a non-noble metal.

25. The method of claim 24, wherein the sacrificial electrode layer comprises a metal selected from the group consisting of aluminum, magnesium, chromium, copper, nickel, and combinations thereof.

26. The method of claim 19, wherein the sacrificial electrode layer is formed using a method selected from the group consisting of electroless plating, thermal deposition, sputtering, chemical deposition, and combinations thereof.

27. The method of claim 19, wherein the MgO powder further comprises a doping element selected from the group consisting of Sc, Al, Ca, Si, and combinations thereof.

28. The method of claim 19, wherein the MgO powder has an average particle diameter ranging from 50 to 1000 nm.

29. The method of claim 19, wherein the solvent is selected from the group consisting of an alcohol-based solvent, a ketone-based solvent, and combinations thereof.

30. The method of claim 19, wherein the electrophoresis liquid comprises 0.1 to 10 wt % of MgO powder based on the total weight of the electrophoresis liquid.

31. The method of claim 19, wherein the sacrificial electrode layer is oxidized at 450 to 600° C.
